(19) United States
(12) Patent Application Publication
(10) Pub. No.: US 2022/0201148 A1
(43) Pub. Date: Jun. 23, 2022

(54) METHODS AND SYSTEMS FOR ALLOWING A USER TO SELECT AND SEND MULTIPLE SCANNED DOCUMENTS TO MULTIPLE DIFFERENT DESTINATIONS

(71) Applicant: XEROX CORPORATION, Norwalk, CT (US)

(72) Inventors: Naveen Kumar Pyla, Visakhapatnam (IN); Sowndarya Chinnaiah, Thanjavur (IN); Sarala Perumal, Chennai (IN)

(73) Assignee: XEROX CORPORATION, Norwalk, CT (US)

(21) Appl. No.: 17/129,082

(22) Filed: Dec. 21, 2020

(51) Int. Cl. H04N 1/04; H04N 1/00

(52) U.S. Cl. CPC H04N 1/0449; H04N 1/0044; H04N 1/00347; H04N 1/00278

(57) ABSTRACT

The present disclosure discloses methods and systems to allow a user to select and send multiple scanned documents to multiple destinations in a single submission. The method includes receiving multiple scan jobs separated using a pre-defined separator at a multi-function device. Each scan job includes a document having one or more pages. The multiple scan jobs are scanned to generate multiple scanned documents, where each scanned document is generated corresponding to a single scan job. Then, each scanned document and corresponding multiple destinations are displayed to a user via a user interface for selection. Based on the user selection, each scanned document is sent to the multiple selected destinations in a single submission.

### TECHNICAL FIELD

The present disclosure relates to the field of scanning. More specifically, the disclosure relates to methods and systems for allowing a user to select and send multiple scanned documents to multiple different destinations in a single submission.

### BACKGROUND

Multi-function devices (MFDs) have become quite common and essential in our day to day life that facilitate various functionalities, such as, printing, photocopying, scanning, etc. Lately, the MFDs have started facilitating multi-document scanning functionality, which allows users to scan multiple documents at the same time, where each document may have one or more pages. Once the multiple documents are scanned, the user can simply select a desired destination for sharing these scanned documents, according to existing solutions. Some existing solutions allow the users to send a single scanned document to fixed multiple destinations (such as email and USB only) at once. Other existing solutions allow the user to send multiple scanned documents but only to a common destination, for example, either to email or USB. Also, the user can send multiple scanned documents to an email address and to the USB at the same time. But if the user wishes to send multiple scanned documents to multiple but different destinations, the user is unable to do so. For instance, if the user wishes to send one scanned document to USB, One Drive, and email as destinations, and the other scanned document to destinations such as FTP, SMB, and Dropbox™, the user is unable to do so using known solutions.

Therefore, there is a need for systems and methods to address the above-mentioned problems.

### SUMMARY

According to aspects illustrated herein, there is a method for allowing a user to select and send multiple scanned documents to multiple different destinations. The method is performed at a multi-function device. The method includes receiving multiple scan jobs separated using a pre-defined separator, where each scan job includes a document having one or more pages; scanning multiple scan jobs to generate multiple scanned documents, where each scanned document corresponds to a single scan job; providing a user interface to the user displaying each scanned document and corresponding multiple different destinations for selection, and based on the user selection, sending each scanned document to the multiple selected destinations in a single submission.

According to further aspects illustrated herein, a multi-function device is provided. The multi-function device includes a duplex automatic document handler (DADH) for receiving multiple scan jobs separated using a pre-defined separator, each scan job includes a document having one or more pages; a scanner for scanning multiple scan jobs to generate multiple scanned documents, where each scanned document corresponds to a single scan job; a user interface for displaying each scanned document and corresponding multiple different destinations for selection by a user; and a network controller for sending each scanned document to the multiple selected destinations in a single submission, based on the user selection.

According to further aspects illustrated herein, a non-transitory computer-readable medium is disclosed. Th non-transitory computer readable medium includes instructions executable by a processing resource to: at an application accessible at a multi-function device: receive multiple scan jobs separated using a pre-defined separator, where each scan job includes a document having one or more pages; scan multiple scan jobs to generate multiple scanned documents, where each scanned document corresponds to a single scan job; provide a user interface to a user to display each scanned document and corresponding multiple different destinations for selection; and based on the user selection, send each scanned document to the multiple selected destinations in a single submission.

Other and further aspects and features of the disclosure will be evident from reading the following detailed description of the embodiments, which are intended to illustrate, not limit, the present disclosure.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1 shows an exemplary environment in which various embodiments of the present disclosure can be practiced.

FIG. 2 is a block diagram illustrating various components of a multi-function device, in accordance with an embodiment of the present disclosure.

FIGS. 3A, 3B, and 3C show exemplary snapshots illustrating an implementation of the present disclosure.

FIG. 4 is a method flowchart for allowing a user to select and send multiple scanned documents to multiple different destinations in a single submission, in accordance with an embodiment of the present disclosure.

### DESCRIPTION

A few inventive aspects of the disclosed embodiments are explained in detail below with reference to the various figures. Embodiments are described to illustrate the disclosed subject matter, not to limit its scope, which is defined by the claims. Those of ordinary skill in the art will recognize a number of equivalent variations of the various features provided in the description that follows.

### Non-Limiting Definitions

In various embodiments of the present disclosure, definitions of one or more terms that will be used in the document are provided below. For a person skilled in the art, it is understood that the definitions are provided just for the sake of clarity and are intended to include more examples in addition to the examples provided below.

The term “multi-function device” is a single device or a combination of multiple devices, to perform one or more functions such as, but not limited to, printing, imaging, scanning, copying, and so forth. The multi-function device may include software, hardware, firmware, and combination thereof. In the context of the current disclosure, the multi-function device allows a user to select and send multiple scanned documents to multiple different destinations in a single submission.

The term “multiple scan jobs” refer to multiple documents, which a user wants to scan. Each scan job corresponds to a single document, where a single document may include one or more pages. In one example, multiple scan jobs include a bundle of documents such as a driving license, lecture notes, legal agreements, etc.

A “pre-defined separator” refers to any separator that can be placed between multiple scan jobs to separate scan jobs from each other. For example, the pre-defined separator may be a blank page, which can be a white blank page or a full colored blank page. In another example, the pre-defined separator may be a page including an image (e.g., a pre-defined barcode or a pre-defined Quick Response (QR) code) which is readable as a separator by the multi-function device. These are just 2 examples, but other pre-defined separators as known or later developed separators may be used. In one example, if there are 3 scan jobs, where each scan job represents a document of a single page, then at the end of each document, a blank page is placed. Here one blank page is placed after the first scan job and a second blank page is placed after the second scan job.

A “scanned document” is an output obtained after scanning a single document or a scan job. In context of the present disclosure, multiple scanned documents refer to output obtained after scanning multiple scan jobs/documents. The scanned document is in a virtual or software form (embodied in a software file). The virtual form can also be referred to as a digital form or an electronic version. The scanned document may also be termed as a scanned output file.

The term “multiple scanned documents to multiple different destinations” may cover any variations. For example, this may include sending multiple scanned documents to a single destination where each destination is different from each other. If there are 3 scanned documents, then one scanned document is sent for printing, the second scanned document is sent to OneDrive and the third scanned document is sent to email. Another variation may include sending multiple scanned documents to multiple different destinations, where destinations may be same for some scanned documents, and different for other documents. If there are 3 scanned documents, then one scanned document may be sent for printing and USB, the second scanned document may be sent to FTP, USB, OneDrive, and the third scanned document may be sent to email, SFTP, and SMB.

The term “destinations” refer to locations where the user wishes to send/store the scanned documents. Various examples of the destinations may be Universal Serial Bus (USB), email, Server Message Block (SMB), Secure File Transfer Protocol (SFTP), File Transfer Protocol (FTP), Dropbox™, print, Google Drive, Microsoft OneDrive, scanning to network multi-function devices, and so on. For example, if the user wishes to send the scanned document to USB, then “scan to USB” option may be shown to the user. For example, if the user wishes to send the scanned document to email, then “scan to email” option may be shown to the user. For example, if the user wishes to send the scanned document for printing, then “scan to print” option may be shown to the user. For example, if the user wishes to send the scanned document to FTP, then “scan to FTP” option may be shown to the user. For example, if the user wishes to send the scanned document to SMB, then “scan to SMB” option may be shown to the user. For example, if the user wishes to send the scanned document to OneDrive, then “scan to OneDrive” option may be shown to the user.

The term “single submission” refers to sending multiple scanned documents to multiple as well as different destinations at a stretch i.e., without requiring the user to rescan any job. For example, if there are 3 scanned documents, where one scanned document needs to be sent to FTP and email, the second scanned document is to be sent for printing, and the other scanned document is to be sent to any cloud server, OneDrive, email, and USB, then the user can select these 3 scanned documents to respective destinations at the same time and can be further sent to respective multiple selected destinations. To this end, the user is not required to send each scanned document one by one to the required multiple destinations instead all the three scanned documents are sent to the respective multiple selected destinations on a single submission.

### Overview

The present disclosure discloses methods and systems that allow a user to select and send multiple scanned documents to multiple different destinations. The multiple scanned documents are sent to multiple different destinations in a single submission i.e., at the same time. The methods and systems receive multiple scan jobs, separates multiple scan jobs into different scanned documents after scanning, allow a user to select multiple different destinations based on his preference, and send the scanned documents to multiple different destinations as selected by the user. The disclosure facilitates a simple and a faster scanning workflow where multiple scanning documents are sent to respective multiple destinations, as needed.

### Exemplary Environment

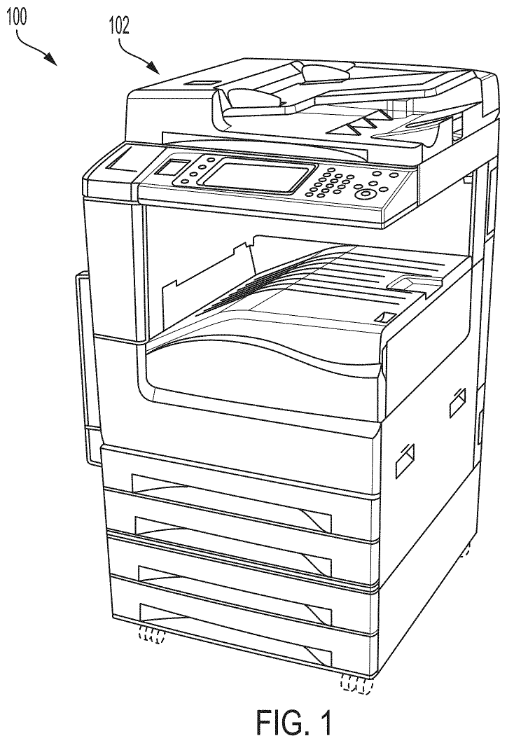

FIG. 1 shows an exemplary environment 100 in which various embodiments of the disclosure can be practiced. The environment 100 includes a multi-function device 102. In place of the multi-function device 102, the environment 100 may include a scanner for implementing the disclosure. While not shown explicitly, the multi-function device 102 includes various suitable components that are required to perform various operations associated with the multi-function device 102.

The multi-function device 102 provides one or more functionalities such as printing, scanning, imaging, copying, or the like. In context of the present disclosure, the multi-function device 102 allows a user to select multiple different destinations for each scanned document and then sends the scanned documents to the multiple different destinations as selected by the user.

In implementation, the user submits multiple scan jobs including multiple documents for scanning, where each job represents a single document having one or more pages. At the time of submission/before submission, each scan job is separated by a pre-defined separator to separate one scan job from the other scan jobs. For example, a first separator may be placed between a first scan job and a second scan job. Similarly, a second separator may be placed between the second scan job and the next scan job, and so on.

Once separated, the multiple scan jobs with the pre-defined separators are fed to the multi-function device 102 for scanning. The multi-function device 102 scans the multiple scan jobs and generates multiple scanned documents corresponding to the multiple scan jobs. Once generated, multiple scanned documents are automatically saved/stored in the multi-function device 102. Thereafter, the multi-function device 102 presents the multiple scanned documents along with multiple different destinations via the user interface. Through the user interface, the user selects a scanned document and a corresponding destination. The user selects destinations for each scanned document via the user interface. Here, through the user interface, the user can select the multiple scanned documents and corresponding multiple different destinations at a stretch i.e., as a continuous activity. Upon successful selection, the multi-function device 102 maps each scanned document to the user's selected destinations. Once mapping is successfully completed, all the mapped scanned documents are copied into corresponding destinations substantially at the same and finally sent to the selected destinations. This way, the user can select and send multiple scanned documents to multiple different destinations in a single submission. The term “Mapping” may include maintaining which destination is selected for which scanned document and/or may include copying scanned documents to respective selected destinations without limiting the scope of disclosure.

### Exemplary Block Diagram

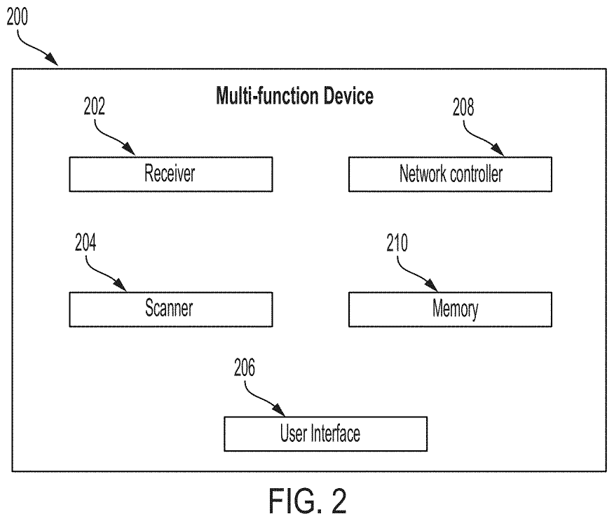

FIG. 2 is a block diagram illustrating various components of a multi-function device 200, in accordance with an embodiment of the present disclosure. The multi-function device 200 may perform functions and operations similar to the multi-function device 102 (shown in FIG. 1).

As shown, the multi-function device 200 includes a receiver 202, a scanner 204, a user interface 206, a network controller 208, and a memory 210. The components 202, 204, 206, 208, 210 are connected to each other via a conventional bus or a later developed protocol. Further, the components 202, 204, 206, 208, and 210 communicate with each other for performing various functions.

The receiver 202 receives multiple scan jobs. The multiple scan jobs refer to documents submitted by the user for scanning, where each scan job corresponds to a single document. The document may have one or more pages without limiting the scope of disclosure. Each scan job is separated by a pre-defined separator such as a blank page. But other types of separators may be used. Here, while submitting the scan jobs for scanning, the user inserts a blank page between the consecutive scan jobs to separate one scan job from other scan jobs.

In one example, the receiver 202 may be a Duplex Automatic Document Feeder (DADH), where the user feeds all documents separated by a pre-defined separator, for scanning. The DADH automatically takes one page after another till all submitted documents are scanned. This way the receiver 202 receives multiple scan jobs and automatically feeds the scan jobs to the scanner 204 for scanning Those skilled in the art will appreciate that other types of receiver 202 can also be used without departing from the scope of the present disclosure.

Upon receiving the multiple scan jobs from the receiver 202, the network controller 208 triggers the scanner 204 to scan the received jobs. Those skilled in the art would appreciate that the network controller 208 may be implemented as one or more microprocessors, microcomputers, microcontrollers, digital signal processors, central processing units, state machines, logic circuitries, and/or any devices that manipulate commands/signals based on operational instructions.

Based on the trigger from the network controller 208, the scanner 204 processes the scan jobs. The scanner 204 scans multiple scan jobs as submitted and generates scanned documents corresponding to each scan job. At the time of scanning, the scanner 204 identifies a blank page placed in between the scan jobs and considers the blank page as a separator to separate one scan job from the other scan jobs. This way, the scanner 204 generates scanned documents corresponding to multiple scan jobs. For example, if the user has submitted five scan jobs, five scanned documents are generated. The scanned documents may be in any desired format such as JPG, JPEG, PDF, or the like.

The scanner 204 sends the scanned documents to the network controller 208 for further processing. The network controller 208 then processes the multiple scanned documents and further segregates into different scanned documents based on the pre-defined separator. The network controller 208 identifies a blank page placed between the scan jobs and considers the blank page as a separator to separate one scanned document from the other scanned document. For example, the network controller 208 considers all scanned pages as one scanned document till it identifies a blank page and considers subsequent scanned pages as next scanned document till it identifies next blank page and so on. The network controller 208 stores all the scanned documents corresponding to the multiple scan job in the memory 210 of the multi-function device 200. In one example, the memory 210 may be a temporary memory for storing all scanned documents. However, those skilled in the art will appreciate that the memory 210 may include any computer-readable medium known in the art including, but not limited to, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes. The memory 210 holds one or more computer-readable instructions that are executed by the network controller 208/processor to run various operations of the multi-function device 200.

Referring back to the stored scanned documents, the network controller 208 fetches the stored scanned documents and presents the scanned documents along with multiple destinations to the user through the user interface 206. The network controller 208 presents the scanned documents with a preview corresponding to each scanned document. The preview (also referred to as a thumbnail) is created based on additional information processed at the time of scanning. The preview may include, but not limited to, miniaturized image of the first page of each scanned document, title of each scanned document, a main image of the scanned document, and so on. The preview may be displayed along with the corresponding scanned documents on the user interface 206 to assist the user in identifying the scanned documents corresponding to the scan jobs.

In context of the present disclosure, the network controller 208 presents each scanned document in the form of a thumbnail along with multiple different destinations for selection via the user interface 206. For example, each scanned document is presented with multiple and different destination options such as send to email, send to USB, send to SMB, send to FTP, send to SFTP, send to OneDrive, send to cloud, send to print, or the like. These are few exemplary destinations but there can be more and different destinations that can be included for implementing the current disclosure. The user selects each scanned document and corresponding multiple different destinations via the user interface 206.

Upon successful selection by the user, the controller 208 receives the selected destinations for each scanned document. The network controller 208 then maps each scanned document to respective selected destinations. While mapping, the controller 208 checks the feasibility of selected destinations. For example, if the destination selected for a scanned document is USB, the network controller 208 checks if a USB device is connected to the multi-function device 200. In case the USB device is not connected, the network controller 208 provides a notification to the user, corresponding to the scanned document such as ‘please connect USB’. In another example, if the destination selected for a scanned document is email, the network controller 208 prompts the user via the user interface 206 to add one or more email addresses. In yet another example, if the destination selected for a scanned document is SFTP, the network controller 208 prompts the user via the user interface 206 to add the host address and other relevant information pertaining to the selected destination such as username, path, etc. In additional examples, to send the scanned documents to DropBox, Google Drive and Microsoft OneDrive, the network controller 208 requests the user to provide their configured email address and password. This way, the user can interact with the multi-function device 200 via the user interface 206 to select multiple different destinations against each scanned document.

Once the information pertaining to the selected destinations is provided, the network controller 208 maps each scanned document to the user's selected destinations in parallel. The user submits the scanned documents to send the scanned documents to their selected destinations. The network controller 208 finally sends each scanned document to the respective user selected destinations simultaneously.

In one example, once the scanned documents are successfully sent to the multiple selected destinations, the network controller 208 automatically removes the scanned documents from the memory 210. However, in another example, the controller 208 removes the scanned documents from the memory 210 only upon receiving confirmation from the user. The network controller 208 may keep all scanned documents in the memory 210 as-is for use by other services. The memory 210 stores all the scanned documents and corresponding user selected destinations for each scanned document. The network controller 208 retrieves the scanned documents from the memory 210, for example, displaying to the user through the user interface 206. The memory 210 may be a pre-defined memory such as temporary memory or other location in the multi-function device 200.

The user interface 206 displays a preview of each scanned document to the user for identification and further displays multiple different destinations corresponding to each scanned document. The user can select destinations for each scanned document as per his choice. For example, the user can select a single destination but different destination for each scanned document. In other example, the user can select multiple destinations for each scanned document, where multiple destinations may be same, different or a combination thereof.

The multi-function device 200 provides multiple different destinations for each scanned document, allows the user to select any multiple different destination as per his choice and further sends each scanned document to the user's selected destinations.

### Exemplary Snapshots

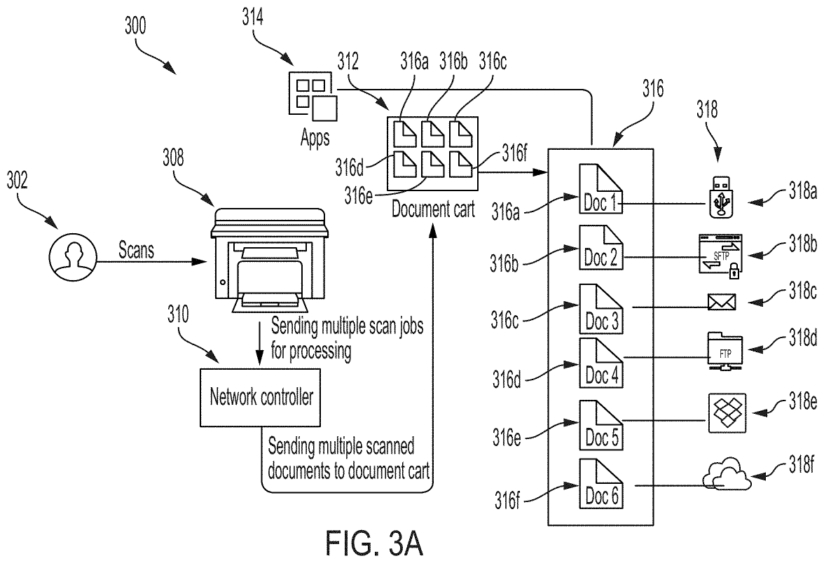

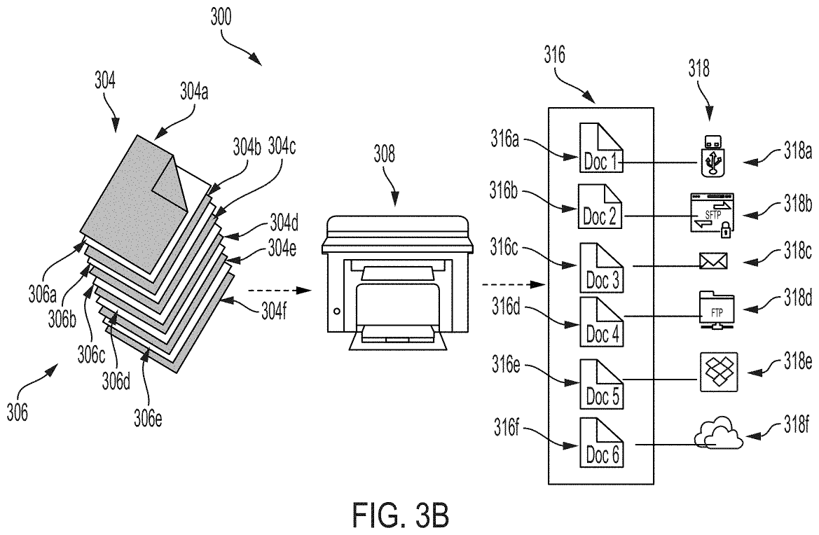

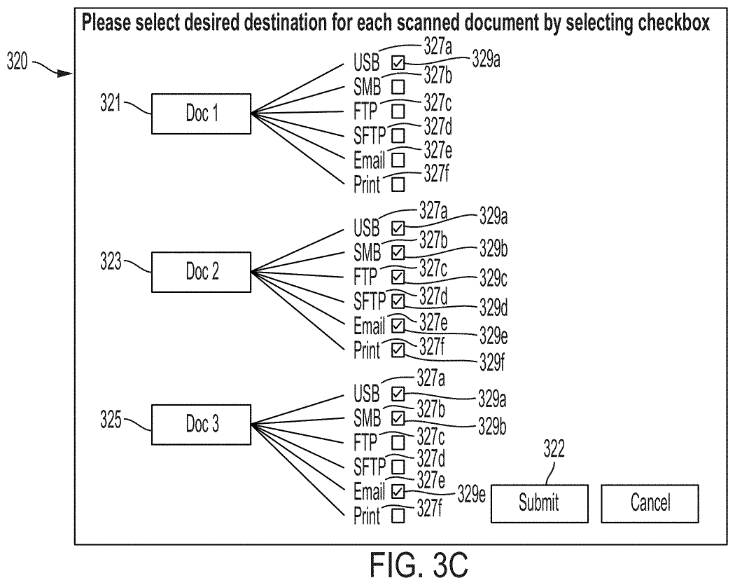

FIGS. 3A, 3B, and 3C are exemplary snapshots illustrating implementation of the present disclosure.

Referring first to FIGS. 3A and 3B, an implementation 300 begins when a user 302 wishes to scan multiple scan jobs 304 using a multi-function device such as 308. The multiple scan jobs 304 include six individual jobs including 304a, 304b, 304c, 304d, 304e, and 304f (collectively 304). Each scan job 304a, 304b, 304c, 304d, 304e, and 304f refers to a document for scanning having one or more pages. For the sake of clarity, each scan job 304a, 304b, 304c, 304d, 304e, and 304f is shown to include a single page, however, the scan jobs 304 can include any number of pages without limiting the scope of disclosure.

Before the user 302 submits the scan jobs 304 to the multi-function device 308 for scanning, the scan jobs 304 are separated using pre-defined separators 306. Here, the pre-defined separators 306 include blank pages that are inserted between the scan jobs 304. In particular, one blank page is inserted between two consecutive scan jobs. As shown in FIG. 3B, a first pre-defined separator 306a is inserted between the scan jobs 304a and 304b, a second pre-defined separator 306b is inserted between the scan jobs 304b and 304c, a third pre-defined separator 306c is inserted between the scan jobs 304c and 304d, a fourth pre-defined separator 306d is inserted between the scan jobs 304d and 304e, and a fifth pre-defined separator 306e is inserted between the scan jobs 304e and 304f.

Once the scan jobs 304 are separated using the pre-defined separators, the user submits the multiple scan jobs 304 with the pre-defined separators 306 to the multi-function device 308 for scanning. The multi-function device 308 generates scanned documents 316a, 316b, 316c 316d, 316e and 316f (collectively 316). The multi-function device 308 sends the multiple scanned documents 316 to the network controller 310 for processing. The network controller 310 processes the multiple scanned documents 316, segregates multiple scanned documents 316 based on the pre-defined separators 306 and sends to a document cart 312, the document cart 312 represents a storage for storing multiple scanned documents 316. Here, the network controller 310 reads each pre-defined separator 306 as an input to segregate the scanned documents.

Once the scanned documents 316 are processed, the scanned documents 316 are automatically saved/stored in an application 314. The application 314 can be in the form of a web application hosted on the Internet. However, for the sake of easy discussion, the application 314 may be a pre-installed application on the multi-function device 308. The network controller 310 can access the application 314, which further includes a document cart 312 for storing all scanned documents 316. The network controller 310 then retrieves each scanned document 316 from the document cart 312 and presents to the user 302 along with multiple destinations 318. The user 302 selects any destinations for each scanned document 316. In the current example, it can be considered that the user 302 selects a single destination for each scanned document 316. As shown in FIGS. 3A and 3B the user 302 selects destination USB (marked as 318a) for scanned document 316a, SFTP (marked as 318b) for scanned document 316b, email (marked as 318c) for scanned document 316c, FTP (marked as 318d) for scanned document 316d, DropBox™ (marked as 318e) for scanned document 316e, and Cloud Server such as OneDrive (marked as 318f) for scanned document 316f. The network controller 310 then maps each scanned document against the user selected destination and then sends to the destinations.

Referring to FIG. 3C, an exemplary snapshot of a user interface 320 of the multi-function device 308 is shown. The user interface 320 shows how the scanned documents and multiple different destinations are presented to the user for selection. As shown, the user interface 320 shows three scanned documents such as 321, 323 and 325 along with multiple different destinations such as USB 327a, SMB 327b, FTP 327c, SFTP 327d, Email 327e and print 327f (collectively 327) for each scanned document 321, 323 and 325. The scanned documents 321, 232 and 325 are presented to the user 302 along with the multiple destinations 327 for user's selection. The user 302 can select any destination using checkboxes as provided. As clearly shown in FIG. 3C, the user 302 selects the destination USB 327a for the scanned document 321, wherein the selection is shown via check box 329a. The user 302 selects the destinations USB 327a, SMB 327b, FTP 327c, SFTP 327d, Email 327e and print 327f for the scanned document 323, where the selection is shown via checkboxes 329a, 329b, 329c, 329d, 329e and 329f, respectively. Similarly, the user 302 selects the destinations USB 327a, SMB 327b, and Email 327e for the scanned document 325, where the selection is shown via checkboxes 329a, 329b and 329e. Upon successful selection of destinations, the user clicks on a submit button 322 to send the scanned documents 321, 323 and 325 to the multiple selected destinations at a stretch/simultaneously. This way, the disclosure allows the user 302 to select and then send the multiple scanned documents to multiple different destinations in a single submission i.e., as a continuous activity and without requiring the user to rescan any document. The destinations as shown in FIGS. 3A-3C are exemplary in nature and more variations to these can be included for implementing the current disclosure.

### Exemplary Method Flowchart

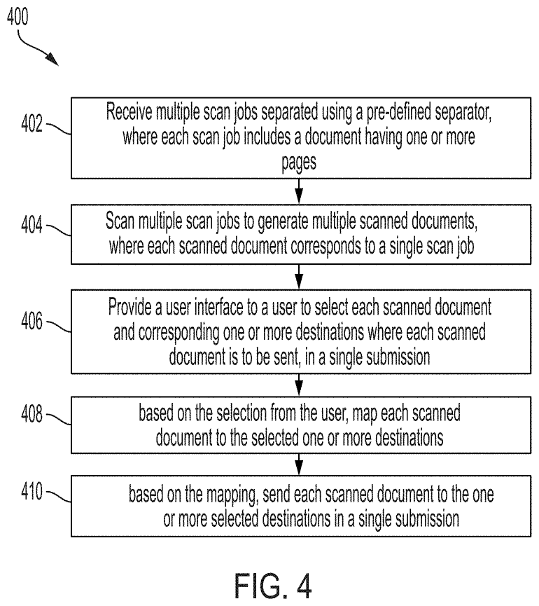

FIG. 4 is a method flowchart 400 for allowing a user to select and send multiple scanned documents to multiple different destinations in a single submission. The method 400 may be implemented by the multi-function device 102, the multi-function device 200, and the multi-function device 308 as shown in FIGS. 1, 2, and 3A-3B, respectively.

The method 400 begins when a user wishes to select and send multiple scanned documents to multiple different destinations. Initially, the user submits multiple documents for scanning, referred to as scan jobs. Each document submitted for scanning is considered as a single scan job. The document may have one page or may have multiple pages. The document may belong to the same user or may belong to different users without limiting the scope of the disclosure. Before submitting the documents for scanning, the user inserts a pre-defined separator such as a blank page to differentiate one document from the other document. This way the user submits multiple scan jobs to the multi-function device.

Once submitted by the user, at block 402, multiple scan jobs are received for scanning at the multi-function device, where each scan job is separated using a pre-defined separator.

At block 404, the multiple scan jobs are scanned to generate multiple scanned documents corresponding to each scan job. Upon successful scanning, scanned documents are processed to segregate into different documents based on the pre-defined separator. Here, the multi-function device is configured to recognize blank page as the separator and identifies different scanned documents based on the same. This way, the scanned documents are separated and identified. The scanned documents are then stored in a pre-defined memory of the multi-function device.

At block 406, a user interface is provided/presented to the user displaying each scanned document and corresponding multiple different destinations for selection. Here, each scanned document is to be sent in a single submission. The user can select a single but different destination for each scanned document through the user interface. The user can select multiple different destinations for each scanned document through the user interface. The user can select single destination for some scanned documents and can select multiple different destinations for remaining scanned documents. These are few examples, but the user can select the destinations for scanned documents in any possible way.

Each scanned document is retrieved from the pre-defined memory and displayed to the user. A preview/thumbnail of each scanned document is presented to the user through the user interface for easy identification. The preview/thumbnail may include any suitable information that assists the user in identifying the individual scanned documents including, but not limited to, a miniaturized image of a front page of the document, a title of the document, or the like. The user identifies each scanned document and selects required destinations/services/actions for each scanned document.

Upon successful selection by the user, at block 408, each scanned document is mapped to the selected multiple destinations. Mapping includes copying each scanned document to respective selected destinations at the same time.

Finally, at block 410, each scanned document is sent to the respective selected destinations in a single submission. Sending includes mapping the scanned document to these destinations substantially at the same time. The scanned documents may be automatically deleted from the pre-defined memory after each scanned document is sent to the respective selected destinations. This way, the user can select as well as send multiple scanned documents to multiple different destinations.

Additionally, the method 400 can be implemented in the form of a non-transitory computer-readable medium including instructions executable by a processing resource to: scan multiple documents, generate scanned documents; presents a user interface displaying multiple different destinations for each scanned document for user selection and sends the scanned documents to the user selected destinations.

The present disclosure discloses methods and systems for allowing a user to select and send multiple scanned documents to multiple different destinations in a single submission. The disclosure reduces manual effort in segregating one scanned document from other scanned documents. The methods and systems store scanned documents locally in a pre-defined memory or a temporary memory, hence the scanned documents can be used among different services/destinations. The methods and systems send the scanned documents to respective mapped destinations substantially at the same time. Therefore, no rescanning of jobs is required. The methods and systems reduce the workflow of scanning multiple documents to multiple destinations. The methods and systems allow the user take different actions on each scanned document independently as per his preferences. For example, one scanned document can be printed, another scanned document can be sent to an email id, yet another scanned document can be stored in a portable device such as pen drive, and so on. The methods and systems allow the user to select and send multiple scanned documents to multiple different destinations using a single workflow, thereby saving the user time. The methods and systems allow the user to selectively send multiple scanned documents to multiple different destinations with ease and without needing the user to rescan any documents. The methods and systems allow the user to send each scanned document of the bunch of scanned documents to multiple different destinations on a single user request.

The disclosure is useful in office environment where different documents needs to be scanned and shared among different group of users at a stretch. For example, the disclosure can be implemented when the user wishes to send a single scanned document to multiple different destinations. In another example, the disclosure can be implemented when the user wishes to select and send multiple scanned documents to multiple destinations, where the destinations may be the same, or different. In further example, the disclosure can be implemented when the user wishes to select and send multiple scanned documents to a single specific destination.

The systems and the methods disclosed herein allow a user to select and submit the multiple scan jobs to multiple destinations using an application. The application is a pre-installed application that is stored in a local drive of a multi-function device. The user can access the application via a user interface of the multi-function device. The user opens the application to select and map the scanned documents to desired multiple destinations. For ease of identification, a preview/thumbnail of the scanned documents is presented on the user interface of the multi-function device such that the user can identify the documents and map them to the desired destinations. The user identifies each scanned document and selects desired destinations against each of the scanned documents. Once the scanned documents are mapped to their corresponding destinations, the user can submit the mapped documents and send the documents to multiple selected destinations simultaneously/in a single click.

The order in which the method is described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system and/or the apparatus and/or any electronic device (not shown).

The above description does not provide specific details of manufacture or design of the various components. Those of skill in the art are familiar with such details, and unless departures from those techniques are set out, techniques, known, related art or later developed designs and materials should be employed. Those in the art are capable of choosing suitable manufacturing and design details.

Note that throughout the following discussion, numerous references may be made regarding servers, services, engines, modules, interfaces, portals, platforms, or other systems formed from computing devices. It should be appreciated that the use of such terms is deemed to represent one or more computing devices having at least one processor configured to or programmed to execute software instructions stored on a computer readable tangible, non-transitory medium or also referred to as a processor-readable medium. For example, a server can include one or more computers operating as a web server, database server, or other type of computer server in a manner to fulfill described roles, responsibilities, or functions. Within the context of this document, the disclosed devices or systems are also deemed to comprise computing devices having a processor and a non-transitory memory storing instructions executable by the processor that cause the device to control, manage, or otherwise manipulate the features of the devices or systems.

Some portions of the detailed description herein are presented in terms of algorithms and symbolic representations of operations on data bits performed by conventional computer components, including a central processing unit (CPU), memory storage devices for the CPU, and connected display devices. These algorithmic descriptions and representations are the means used by those skilled in the data processing arts to convey the substance of their work most effectively to others skilled in the art. An algorithm is generally perceived as a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be understood, however, that all of these and similar terms are to be associated with the appropriate physical quantities and are merely convenient labels applied to these quantities. Unless specifically stated otherwise, as apparent from the discussion herein, it is appreciated that throughout the description, discussions utilizing terms such as receiving, scanning, generating, copying, sending, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The exemplary embodiment also relates to an apparatus for performing the operations discussed herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the methods described herein. The structure for a variety of these systems is apparent from the description above. In addition, the exemplary embodiment is not described with reference to any particular programming language. It will be appreciated that a variety of programming languages may be used to implement the teachings of the exemplary embodiment as described herein.

The methods illustrated throughout the specification, may be implemented in a computer program product that may be executed on a computer. The computer program product may comprise a non-transitory computer-readable recording medium on which a control program is recorded, such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in a transitory media, such as a transmittable carrier wave in which the control program is embodied as a data signal using transmission media, such as acoustic or light waves, such as those generated during radio wave and infrared data communications, and the like.

The terminology used herein is for the purpose of describing particular embodiments only and is not intended to be limiting of the disclosure. It will be appreciated that several of the above disclosed and other features and functions, or alternatives thereof, may be combined into other systems or applications. Various presently unforeseen or unanticipated alternatives, modifications, variations, or improvements therein may subsequently be made by those skilled in the art without departing from the scope of the present disclosure as encompassed by the following claims.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. A method for allowing a user to select and send multiple scanned documents to multiple different destinations, the method comprising:
at a multi-function device:
receiving multiple scan jobs separated using a pre-defined separator, wherein each scan job comprising a document having one or more pages, wherein the pre-defined separator comprises a blank page or a page including a pre-defined image;
scanning multiple scan jobs to generate multiple scanned documents, wherein each scanned document corresponds to a single scan job;
providing a user interface to a user displaying each scanned document and corresponding multiple different destinations for selection; and
based on the user selection, sending each scanned document to the multiple selected destinations in a single submission.

2. The method of claim 1, further comprising processing multiple scanned documents to segregate into different scanned documents based on the pre-defined separator.

3. The method of claim 1, further comprising providing the user interface displaying a preview of each scanned document.

4. The method of claim 1, further comprising receiving a selection of the multiple destinations from the user for each scanned document.

5. The method of claim 1, further comprising storing multiple scanned documents in a pre-defined memory.

6. The method of claim 5, further comprising retrieving each scanned document from the pre-defined memory for display via the user interface.

7. The method of claim 1, wherein the multiple destinations comprise at least: print, email, USB, SMB, SFTP, FTP, OneDrive, DropBox™, cloud server, and Email,

8. The method of claim 1, further comprising automatically deleting each scanned document from a pre-defined memory after sending each scanned document to respective selected destinations.

9. The method of claim 1, further comprising simultaneously sending multiple scanned documents to the respective multiple selected destinations,

10. The method of claim 1, further comprising allowing the user to select multiple different destinations for each scanned document.

11. The method of claim 1, further comprising allowing the user to select a single but different destination for each scanned document.

12. The method of claim 1, further comprising mapping each scanned document to the user selected destinations.

13. A multi-function device, comprising:
a duplex automatic document handler (DADH) for receiving multiple scan jobs separated using a pre-defined separator, each scan job comprising a document having one or more pages, wherein the pre-defined separator comprises a blank page or a page including a pre-defined image;
a scanner for scanning multiple scan jobs to generate multiple scanned documents, wherein each scanned document corresponds to a single scan job;
a user interface for displaying each scanned document and corresponding multiple different destinations for selection by a user; and
a network controller for sending each scanned document to the multiple selected destinations in a single submission, based on the user selection.

14. The multi-function device of claim 13, wherein the network controller is for processing multiple scanned documents to segregate into different scanned documents based on the pre-defined separator.

15. The multi-function device of claim 13, wherein the user interface is for displaying a preview of each scanned document.

16. The multi-function device of claim 13, wherein the network controller is for receiving a selection of the multiple destinations from the user for each scanned document.

17. The multi-function device of claim 13, wherein sending each scanned document comprises mapping each scanned document to multiple destinations in parallel.

18. The multi-function device of claim 13, wherein sending each scanned document comprises sending each scanned document to the multiple selected destinations in parallel.

19. The multi-function device of claim 13, further comprising a pre-defined memory to store the multiple scanned documents.

20. A non-transitory computer-readable medium comprising instructions executable by a processing resource to:
at an application accessible at a multi-function device:
receive multiple scan jobs separated using a pre-defined separator, wherein each scan job comprising a document having one or more pages, wherein the pre-defined separator comprises a blank page or a page including a pre-defined image;
scan multiple scan jobs to generate multiple scanned documents, wherein each scanned document corresponds to a single scan job;
provide a user interface to a user to display each scanned document and corresponding multiple different destinations for selection; and
based on the user selection, send each scanned document to user's selected destinations in a single submission.
